(19) United States
(12) Patent Application Publication
(10) Pub. No.: US 2015/0083116 A1
(43) Pub. Date: Mar. 26, 2015

(54) OUTDOOR HEATING APPARATUS

(71) Applicant: Shou Qiang ZHU, Ontario, CA (US)

(72) Inventor: Shou Qiang ZHU, Ontario, CA (US)

(73) Assignee: IP POWER HOLDINGS LIMITED, Hong Kong (CN)

(21) Appl. No.: 14/036,315

(22) Filed: Sep. 25, 2013

(51) Int. Cl. F24C 3/14; B23P 19/00; F24C 3/04

(52) U.S. Cl. CPC F24C 3/14; F24C 3/04; B23P 19/00
USPC 126/91 A; 29/428; 29/890.02; 29/426.1

(57) ABSTRACT

An outdoor heating apparatus may include a top cover, a supporting structure including upper supporting members and lower supporting members, protection members and lower panels. The upper supporting members and the lower supporting members are connected together to form the supporting structure for the heating apparatus. In an exemplary embodiment, each upper supporting member is telescopically connected with corresponding lower supporting member, so the lower supporting member can be received in a hollow space provided by the upper supporting member. Thus, the size of the heating apparatus is significantly reduced, so it can be easily stored and transported. In another embodiment, the protection members can be squeezed into a space between two upper supporting members through two positioning units, so the user does not have to use any screws to secure the protection members.

### FIELD OF THE INVENTION

The present invention is directed to an outdoor heating apparatus, and in particular to an outdoor heating apparatus that has an easy and convenient assembly/disassembly process.

### BACKGROUND OF THE INVENTION

In recent years, outdoor heating devices have become extremely popular in both commercial and residential setting. As the demand for the outdoor heating apparatus increases, the need for inexpensive shipping costs (for both international and domestic shipping) and cheaper installation cost has also increased. Throughout the time, a variety of outdoor heating apparatus has been developed, yet most of these products focused more on the technical aspect of the product without considering additional costs a user may have to incur. Moreover, the user has to spend a long time to go through a complicated assembly process of the heating apparatus.

U.S. Pat. Pub. No. 2011/0076627 to DiVentura discloses an outdoor heater apparatus that has a vertical tube containing a flame exposed along its length to increase the efficiency of the product's function. However, DiVentura does not disclose or suggest how can this heater apparatus be stored and transported. Most likely, this heater apparatus requires a container equal to the height thereof, and thus the shipping and distribution cost of this heater would be relevantly high as the price is reflected on the size of the container. Also, this product has several small parts, such screws and clippers, which may place an unnecessary burden on the consumers to bare the risk of losing important materials during the assembly process. Furthermore, the consumer may have to spend a long time to assemble this heater apparatus. Although this product would bring high utility in term of technicality to the consumers, it is inconvenient for the consumer to assemble it and the consumer may need a large space to store it.

U.S. Pat. Pub. No. 2010/0236544 to Hall Jr et al. discloses a similar type of outdoor heater apparatus as disclosed by DiVentura. However, Hall Jr has placed more emphasis on reducing the costs of distribution. Hall Jr actually reduced the size of the container by breaking the heater into several small and separate parts. Even though the distribution costs may be reduced, there are more separate parts so the consumer may have to spend more time and efforts to assemble the heater apparatus during the assembly process.

Therefore, there remains a need for a new and improved outdoor heating apparatus that can be assembled in a more convenient and efficient manner to overcome the problems presented above.

### SUMMARY OF THE INVENTION

It is an object of the present invention to provide an outdoor heating apparatus that can be assembled in a more convenient and efficient manner.

It is another object of the present invention to provide an outdoor heating apparatus that includes fewer parts so the consumer can more efficiently assemble the heating apparatus.

It is a further object of the present invention to provide an outdoor heating apparatus that the size of the outdoor heating apparatus can be significantly reduced, so it can be more easily stored and transported.

In one aspect, an outdoor heating apparatus may include a top cover, a supporting structure including upper supporting members and lower supporting members, protection members and lower panels. The upper supporting members and the lower supporting members are connected together to form the supporting structure for the heating apparatus. In one embodiment, the supporting structure is a triangular prism.

The outdoor heating apparatus may further include a connecting unit, a securing unit and a glass tube. The glass tube is disposed at nearly the center portion of the supporting structure formed by the upper and lower supporting members. One end of the securing unit is used to connect and secure an upper portion of the glass tube, and the other end of the securing unit is used to connect to one end of the connecting unit. The other end of the connecting unit connects to a bottom portion of the top cover to further secure the upper portion of the glass tube. A lower portion of the glass tube is secured on a top surface of an inner base at a lower portion inside the supporting structure.

In an exemplary embodiment, each upper supporting member is telescopically connected with corresponding lower supporting member. More specifically, the size of the lower supporting member is slightly smaller than that of the upper supporting member, so the lower supporting member can be received in a hollow space provided by the upper supporting member. Thus, the size of the heating apparatus is significantly reduced, so it can be easily stored and transported. The heating apparatus may also include a flame generating unit having a switch located underneath the inner base. When the flame generating unit is turned on, the flame can be generated in the glass tube attached on the other side of the inner base to raise the temperature near the heating apparatus.

A bottom unit is connected to each lower supporting member close to the floor. In one embodiment, the bottom unit is nearly perpendicular to the lower supporting member. In other word, the lower supporting member and the bottom unit forms a substantially L-shaped structure at the bottom portion of the supporting structure. The heating apparatus may include a securing ring that has a plurality of receiving holes and locking elements on the periphery of the securing ring. The securing ring is used to provide more support to the bottom portion of the supporting structure. More specifically, each receiving hole is used to receive corresponding bottom unit and the locking element is configured to insert into corresponding through hole on the bottom unit to further secure the supporting structure.

### BRIEF DESCRIPTION OF THE DRAWINGS

FIG. 1 illustrates an exploded view of a prior art disclosing an outdoor portable heater.

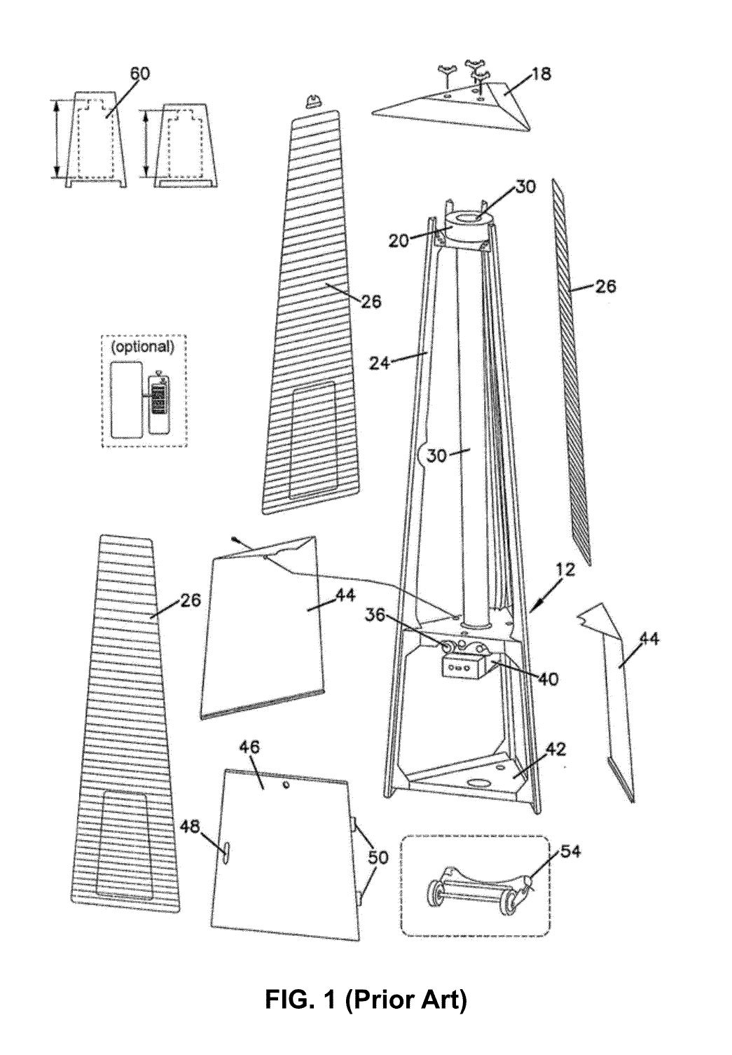

FIG. 2 illustrates an exploded view of a prior art disclosing an outdoor flame heater.

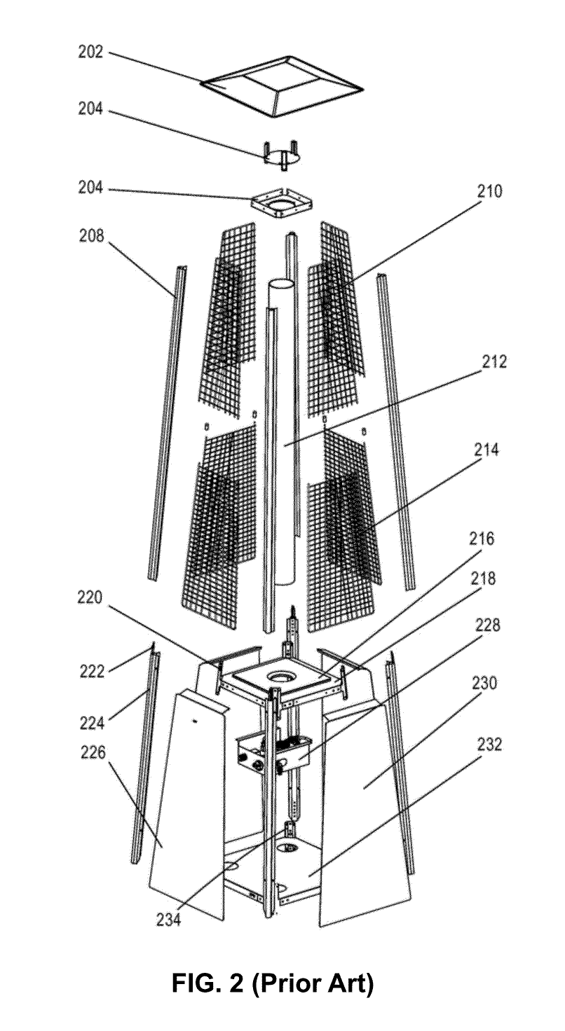

FIG. 3 illustrates a schematic view of the outdoor heating apparatus in the present invention.

FIG. 4 illustrates an exploded view of the outdoor heating apparatus in the present invention.

FIG. 5 illustrates a schematic view of the supporting structure of the outdoor heating apparatus in the present invention.

FIG. 6 illustrates a schematic view of the securing ring of the outdoor heating apparatus in the present invention.

FIG. 7 illustrates a schematic view of the protection member of the outdoor heating apparatus in the present invention.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

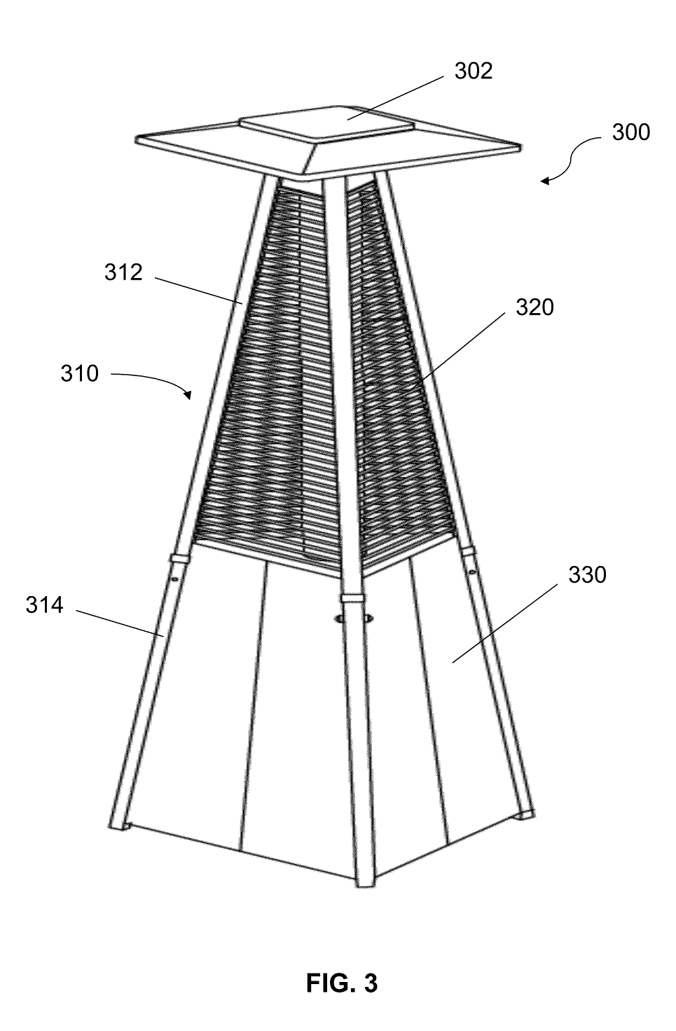

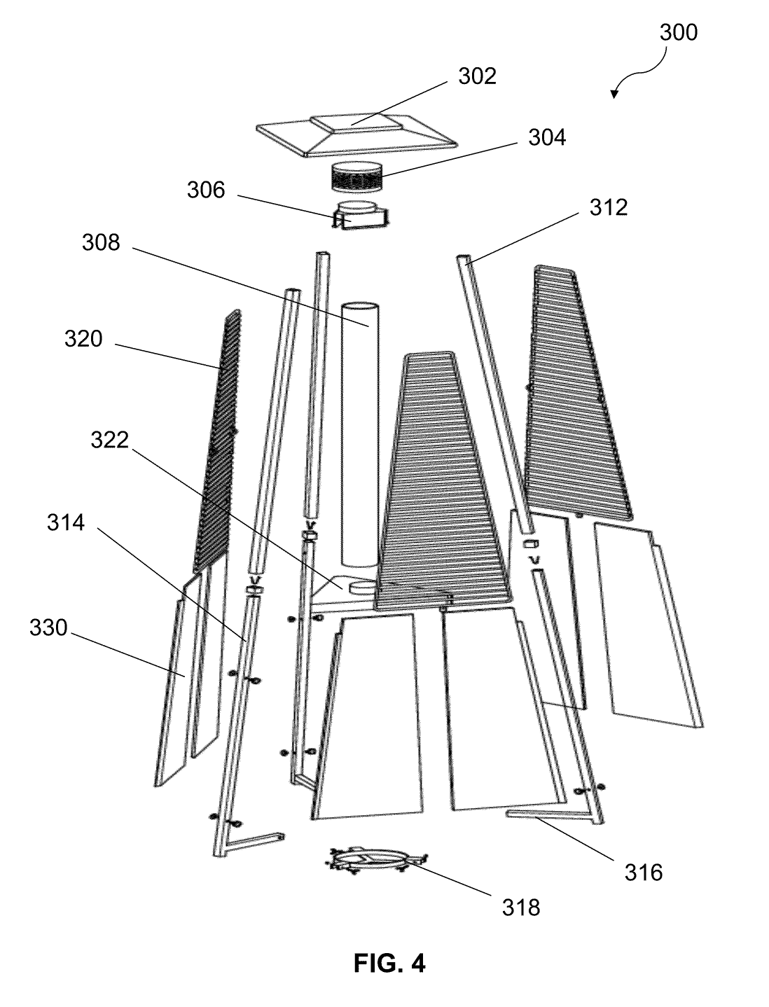

Referring to FIGS. 3 and 4, an outdoor heating apparatus 300 may include a top cover 302, a supporting structure 310 including upper supporting members 312 and lower supporting members 314, a plurality of protection members 320 and a plurality of lower panels 330. The upper supporting members 312 and the lower supporting members 314 are connected together to form the supporting structure 310 for the heating apparatus 300. In one embodiment, the supporting structure 310 is a triangular prism.

The outdoor heating apparatus 300 may further include a connecting unit 304, a securing unit 306 and a glass tube 308. The glass tube 308 is disposed at nearly the center portion of the supporting structure 310 formed by the upper and lower supporting members (312, 314). One end of the securing unit 306 is used to connect and secure an upper portion of the glass tube 308, and the other end of the securing unit 306 is used to connect to one end of the connecting unit 304. The other end of the connecting unit 304 connects to a bottom portion of the top cover to further secure the upper portion of the glass tube 308. A lower portion of the glass tube 308 is secured on a top surface of an inner base 322 at a lower portion inside the supporting structure 310.

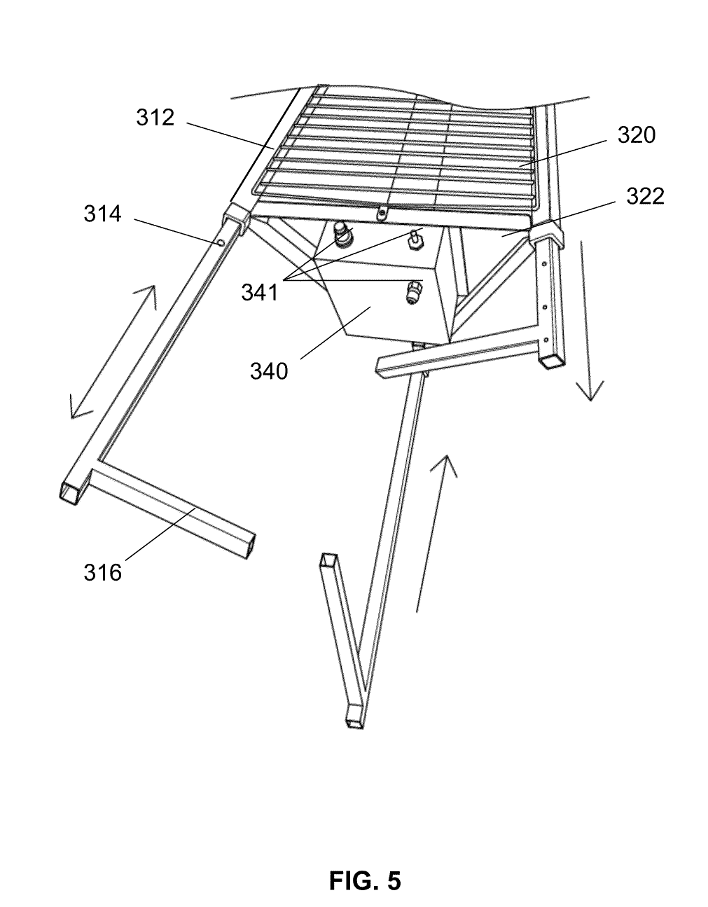

In an exemplary embodiment, each upper supporting member 312 is telescopically connected with corresponding lower supporting member 314, as shown in FIG. 5. More specifically, the size of the lower supporting member 314 is slightly smaller than that of the upper supporting member 312, so the lower supporting member 314 can be received in a hollow space provided by the upper supporting member 312. Thus, the size of the heating apparatus 300 is significantly reduced, so it can be easily stored and transported. The heating apparatus 300 may also include a flame generating unit 340 having a switch 341 located underneath the inner base 322. When the flame generating unit 340 is turned on, the flame can be generated in the glass tube attached on the other side of the inner base 322 to raise the temperature near the heating apparatus 300.

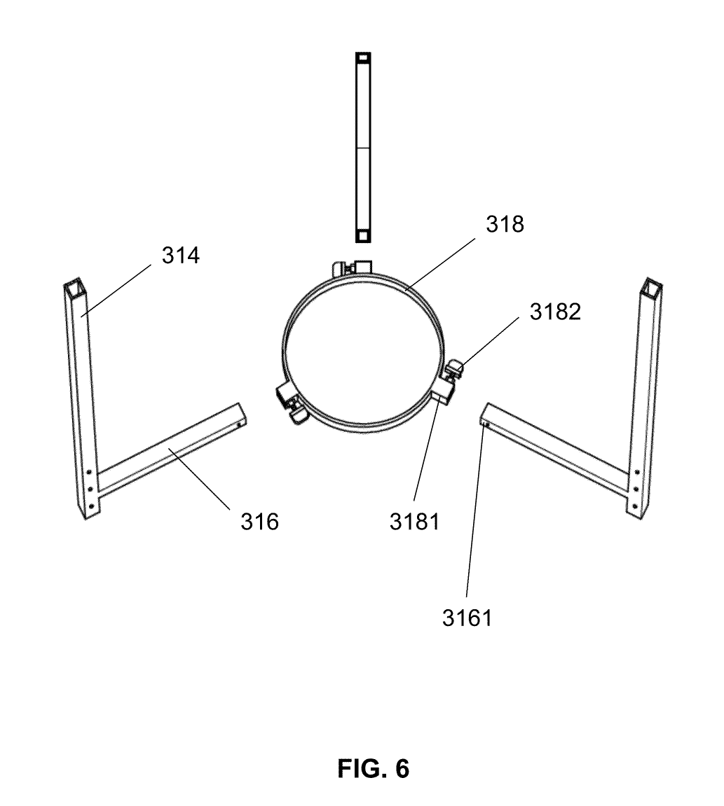

Referring to FIG. 6, a bottom unit 316 is connected to each lower supporting member 314 close to the floor. In one embodiment, the bottom unit 316 is nearly perpendicular to the lower supporting member 314. In other word, the lower supporting member 314 and the bottom unit 316 forms a substantially L-shaped structure at the bottom portion of the supporting structure 310. The heating apparatus 300 may include a securing ring 318 that has a plurality of receiving holes 3181 and locking elements 3182 on the periphery of the securing ring 318. The securing ring 318 is used to provide more support to the bottom portion of the supporting structure 310. More specifically, each receiving hole 3181 is used to receive corresponding bottom unit 316 and the locking element 3182 is configured to insert into corresponding through hole 3161 on the bottom unit 316 to tighten the conjugation of the receiving hole 3181 and the bottom unit 316 to further secure the supporting structure 310.

As illustrated above, conventional outdoor heaters either have too many parts so it is difficult for the user to efficiently put together the heater, or the size of conventional outdoor heaters is too big for the user to store it. As can be seen in FIGS. 3 to 6, when the user wants to disassemble the heating apparatus 300, he/she can first remove the lower panels 330 and the securing ring 318 at the bottom portion of the supporting structure 310. More specifically, each locking element 3182 has to be released to remove the bottom units 316 from the receiving holes 3181. Referring again to FIG. 5, each of the lower supporting member 314 can then be retracted into corresponding receiving space of the upper supporting member 312, so the size of the heating apparatus 300 has been significantly reduced. For some users, the heating apparatus 300 can be stored at the present stage, however, the user can further remove the protection members 320, the glass tube 308, the securing unit 306, the connecting unit 304 and top cover 302 according to the user's preference. It is noted that the size of the heating apparatus 300 is significantly reduced comparing with conventional outdoor heaters, so the user can easily store the heating apparatus 300 in the garage without occupying too much space.

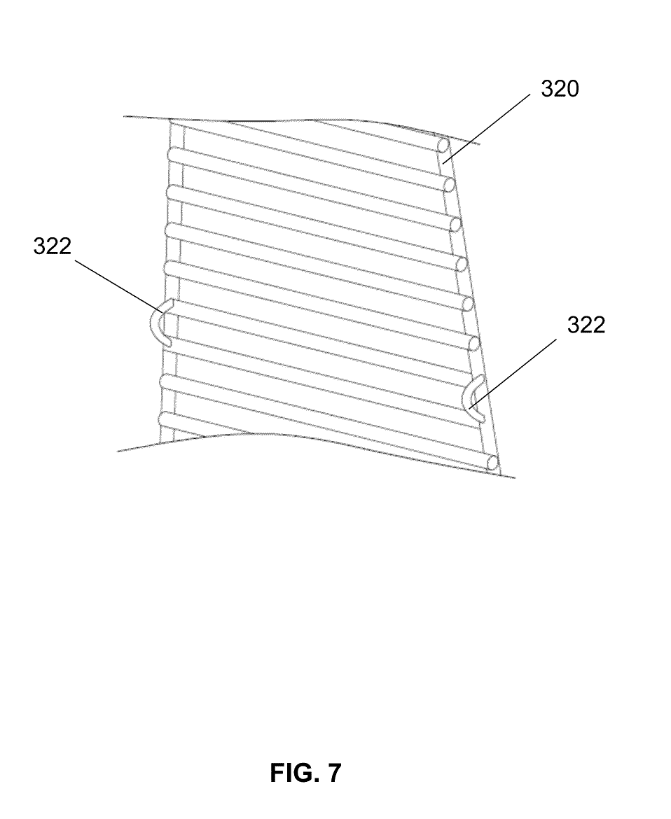

On the other hand, the assembly process for the heating apparatus 300 is relatively easy. The user can first dispose the glass tube 308 at the center portion of the supporting structure 310 and secure the glass tube 308 with the securing unit 306 and then to the connecting unit 304, so the upper portion of the glass tube 308 can be secured to the top cover 302 on the top of the supporting structure 310. The user can then put the protection members 320 on the outer surface of the supporting structure 310. As shown in FIG. 7, it is noted that the protection members 320 can be squeezed into a space between two upper supporting members through two positioning units 322, so the user does not have to use any screws to secure the protection members 320, which saves the user's time and efforts without concerning unnecessary parts of the heating apparatus 300. At the present stage, the lower supporting members 314 are still received in the receiving spaces of the upper supporting members 312.

The lower supporting members 314 can then be pulled out from corresponding upper supporting members 312, and the bottom units 316 of the lower supporting members 314 can be inserted into the receiving holes 3181 and locked by the locking elements 3182 to further secure the supporting structure 310. The lower panels 330 can be attached to the lower portion of the supporting structure 310 to complete the assembly process of the heating apparatus 300.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. An outdoor heating apparatus comprising:
a top cover,
a supporting structure including upper supporting members and lower supporting members,
a plurality of protection members; and
a plurality of lower panels attaching to a lower portion of the supporting structure,
wherein the size of the lower supporting member is slightly smaller than the upper supporting member, and each of the upper supporting members is telescopically connected to corresponding lower supporting member, so the lower supporting member is configured to be received in a hollow space in the upper supporting member to reduce the size of the outdoor heating apparatus.

2. The outdoor heating apparatus of claim 1, further comprising a connecting unit, a securing unit and a glass tube, wherein the glass tube is disposed at nearly a center portion inside the supporting structure, and one end of the securing unit is used to connect and secure an upper portion of the glass tube, and the other end of the securing unit is used to connect to one end of the connecting unit, and the other end of the connecting unit is connected to a bottom portion of the top cover to further secure the upper portion of the glass tube.

3. The outdoor heating apparatus of claim 2, wherein a lower portion of the glass tube is secured on a top surface of an inner base at a lower portion inside the supporting structure.

4. The outdoor heating apparatus of claim 1, wherein each of the lower supporting members includes a bottom unit nearly perpendicular to the lower supporting member at a lower portion thereof.

5. The outdoor heating apparatus of claim 3, wherein each of the lower supporting members includes a bottom unit nearly perpendicular to the lower supporting member at a lower portion thereof.

6. The outdoor heating apparatus of claim 4, further comprising a securing ring that has a plurality of receiving holes and locking elements on periphery of the securing ring.

7. The outdoor heating apparatus of claim 5, further comprising a securing ring that has a plurality of receiving holes and locking elements on periphery of the securing ring.

8. The outdoor heating apparatus of claim 6, wherein each of the receiving hole is used to receive corresponding bottom unit, and the locking element is configured to insert into corresponding through hole on the bottom unit to tighten conjugation of the receiving hole and the bottom unit to further secure the supporting structure.

9. The outdoor heating apparatus of claim 7, wherein each of the receiving hole is used to receive corresponding bottom unit, and the locking element is configured to insert into corresponding through hole on the bottom unit to tighten conjugation of the receiving hole and the bottom unit to further secure the supporting structure.

10. The outdoor heating apparatus of claim 9, further comprising a flame generating unit located underneath the inner base.

11. The outdoor heating apparatus of claim 1, wherein each of the protection members is configured to be squeezed into a space between two upper supporting members through two positioning units.

12. The outdoor heating apparatus of claim 10, wherein each of the protection members is configured to be squeezed into a space between two upper supporting members through two positioning units.

13. A method for quickly assembling an outdoor heating apparatus that has a top cover, a glass tube, a supporting structure including upper supporting members and lower supporting members telescopically connected together, a plurality of protection members, and a plurality of lower panels; the method comprising steps of:
connecting one end of the glass tube to the top cover, and the other end thereof to an inner base inside the supporting structure;
pulling each of the lower supporting members from a receiving space of corresponding upper supporting member;
providing a securing ring to secure the supporting structure at a bottom portion thereof; and
attaching the protection members surrounding the glass tube and the lower panels surrounding a lower portion thereof.

14. The method for quickly assembling an outdoor heating apparatus of claim 13, wherein each of the lower supporting members includes a bottom unit nearly perpendicular to the lower supporting member at a lower portion thereof, and the securing ring has a plurality of receiving holes and locking elements on periphery of the securing ring.

15. The method for quickly assembling an outdoor heating apparatus of claim 14, wherein each of the receiving hole is used to receive corresponding bottom unit, and the locking element is configured to insert into corresponding through hole on the bottom unit to tighten conjugation of the receiving hole and the bottom unit to further secure the supporting structure.

16. The method for quickly assembling an outdoor heating apparatus of claim 13, wherein the step of attaching the protection members surrounding the glass tube includes a step of squeezing each of the protection members into a space between two upper supporting members through two positioning units.

17. A method of quickly disassembling an outdoor heating apparatus that has a top cover, a glass tube, a supporting structure including upper supporting members and lower supporting members telescopically connected together, a plurality of protection members, a securing ring, and a plurality of lower panels; the method comprising steps of:
removing the protection members from a space between two upper supporting members;
removing the lower panels from a lower portion of the supporting structure;
disengaging the securing ring with the lower supporting members at a bottom portion of the supporting structure; and
each of the upper supporting members receiving corresponding lower supporting member therein.

18. The outdoor heating apparatus of claim 1, wherein the supporting structure is a triangular prism.
